(19) United States
(12) Patent Application Publication
(10) Pub. No.: US 2026/0368002 A1
(43) Pub. Date: Nov. 19, 2026

(54) DIGITAL RECORDS SYSTEM AND METHOD OF USE THEREOF

(71) Applicant: Luke Robin WETHERILL, London (GB)

(72) Inventor: Luke Robin WETHERILL, London (GB)

(21) Appl. No.: 19/478,359

(22) PCT Filed: Apr. 22, 2024
(86) PCT No.: PCT/GB2024/051040

§ 371 Date: Oct. 24, 2025

(30) Foreign Application Priority Data
Apr. 25, 2023 (GB) 2306038.7

(51) Int. Cl. G06F 9/54; G06F 21/60

(52) U.S. Cl. CPC G06F 9/54; G06F 21/602

(57) ABSTRACT

A digital records system is provided including a digital data platform; at least a first user interface; and at least a second user interface. Each of the at least first and second user interfaces are communicatively coupled to the digital data platform. At least one of the at least first and second user interfaces is arranged to generate and/or have access to one or more digital records in use. The other of the at least first and second user interfaces is arranged to receive the one or more digital records in use. At least one of the first and second user interfaces is arranged to display and/or generate identification (ID) means and the other of the at least first and second user interfaces is arranged to read and/or detect the ID means. The digital data platform is arranged such that once the ID means are read and/or detected by the other of said first and second user interfaces, it allows communication between the at least first and second user interfaces to take place such that the one or more digital records can be sent from said one at least first and second user interfaces to the other of said at least first and second user interfaces directly, indirectly and/or via the digital data platform.

This invention relates to a digital records system and/or to a method of use thereof. Although the following description refers almost exclusively to a digital records system in the form of a digital receipt system, it will be appreciated by persons skilled in the art that the records of the present invention that are being generated and/or managed by the present invention could be any type of record, such as for example, certificates, tickets, prescriptions, tokens, banking transactions and/or the like.

Conventionally, when a customer makes a purchase at a retail outlet, the customer is presented with a paper receipt in respect of their purchase. Problems with this are that a large amount of paper waste is generated through issuance of paper receipts and the use of paper has a negative environmental impact. For example, recent studies have shown that the carbon footprint of a single paper receipt is about 4.6 g CO₂e. It is also noted that the carbon footprint of a receipt goes beyond the paper content of the receipt. It includes the production, transportation and disposal of the paper receipts which all contribute to the carbon emissions. Currently around 11 billion receipts are produced in the UK each year and around 9.9 billion end up as unrecyclable landfill.

The use of certain chemicals for printing receipts is also known to have detrimental health risks associated with the same and often prevents paper receipts from being recycled. For example, thermal receipt paper has historically been produced using bisphenol A (BPA), and more recently using bisphenol S (BPS), which are chemicals known to be associated with disruption of human hormone systems and which have been shown to result in increased breast cancer cell multiplication.

Furthermore, the time taken to print receipts at the point of purchase (POS) reduces the efficiency of purchase transactions and reduces the experience of both the customer and retail outlet.

In an attempt to overcome the above problems, some retail outlets now ask the customer if they would like their receipt to be sent to them via a text messaging service, such as SMS, or via e-mail to a customer's e-mail address. However, customers are often reluctant to provide personal mobile phone details or e-mail address details to retailers for fear of exploitation of their personal data and/or fear of receiving unwanted junk mail from the retailer and/or associated companies. In addition, it is difficult for a user to keep track and/or manage purchases when they receive separate receipts from retailers via different communication modes, such as e-mail and/or SMS. Furthermore, many existing accounts management systems require a user to manually input and/or scan receipts before they can be logged onto the accounting system.

It is therefore an aim of the present invention to provide a digital records system and/or method of use that overcomes the abovementioned problems.

It is a further aim of the present invention to provide a digital receipt system and/or a method of use thereof.

It is a yet further aim of the present invention to provide a digital user interface for use with a digital records system, a digital receipt system and/or method of use thereof.

It is a yet further aim of the present invention provide a digital data platform for use with a digital records system, a digital receipt system and/or method of use thereof.

According to a first aspect of the present invention there is provided a digital records system;
said digital records system including:
a digital data platform;
at least a first user interface;
at least a second user interface;
each of the at least first and second user interfaces communicatively coupled to the digital data platform;
wherein at least one of the at least first and second user interfaces is arranged to generate and/or have access to one or more digital records in use, and the other of the at least first and second user interfaces is arranged for receive the one or more digital records in use;
wherein at least one of the at least first and second user interfaces is arranged to display and/or generate identification (ID) means and the other of the at least first and second user interfaces is arranged to read and/or detect the ID means;
and wherein said digital data platform is arranged such that once the ID means are read and/or detected by the other of said first and second user interfaces, it allows communication between the at least first and second user interfaces to take place such that the one or more digital records can be sent from said one at least first and second user interfaces to the other of said at least first and second user interfaces directly, indirectly and/or via the digital data platform.

Thus, the present invention provides a secure universal digital system for allowing a digital record to be generated and securely and efficiently transferred between at least two different users or user interfaces. This removes the need for paper copies of the record to be generated, it speeds up and improves the efficiency of transfer of the record between two or more users, allows for the anonymous transfer of records, allows for carbon footprint savings and provides an improved means for tracking and/or managing records by the at least first and/or second users. The system is scalable and can operate with different data formats, different software and/or hardware formats and/or the like.

In one embodiment the user interface generating and/or having access to the digital record is the same user interface that is arranged to generate and/or display the ID means. Preferably the user interface that is arranged to receive the one or more digital records is the same user interface that is arranged to read and/or detect the ID means. For example, having a retailer generating the ID means rather than the consumer generating the ID means provides enhanced security consistent data integrity, seamless integration with existing systems, provides a standardized and convenient experience for users while ensuring customer privacy and enabling real time verification and analytics for the retailer.

Preferably the digital record that is generated and/or communicated between the at least first and second user interfaces is in the form of a digital data record or digital data file. Thus, for example, the digital record contains a packet of data representative of a transaction or event.

In one embodiment the digital record can be in the form of or include any or any combination of one or more receipts, transaction records, point of sale (POS) receipts, purchase and/or sale transaction receipts, tickets, tokens, certificates, invoices, pro-forma invoices, banking transactions, financial transactions, prescriptions and/or the like.

In one embodiment the digital record is generated at the start of, as a result of, during, and/or following completion of, a transaction, such as for example on completion of a purchase, return of a purchased item, financial transaction and/or sale transaction. However, the digital record could be in the form of a pre-prepared invoice, a returns invoice, pro-forma invoice and/or the like that is issued prior to a purchase or financial transaction taking place or that is accessible via the user interface.

Preferably the digital record is generated in place of a conventional paper record. However, a paper record could still be generated via the system in addition to or instead of the digital record if required.

Thus, in one embodiment, system selection means and/or user selection means may be provided with and/or associated with the at least first and/or second user interfaces to allow system selection and/or user selection for a digital record to be generated; for a paper record to be generated, or both a digital record and a paper record to be generated for a particular transaction or event.

Preferably the one or more digital records or data files are encrypted or are capable of being encrypted. Thus, preferably encryption means or mechanism can be provided with and/or associated with the digital records system, the digital data platform, databases associated with the at least first and/or second user interfaces or digital data platform, and/or the at least first and/or second user interfaces.

For example, purchase transaction receipts contain sensitive financial data, such as payment details, customer data, payment card details, purchase transaction details and/or the like. The digital receipt generated from such a transaction can therefore be encrypted so as to keep the digital data contained therein confidential.

Preferably any known, standard and/or conventional encryption protocol and/or encryption means or mechanism can be used for encryption of the digital record or data file in use. For example, quantum encryption, Secure Socket Layer (SSL), Transport Layer Security (TLS) encryption, Advanced Encryption Standard (AES) can be used.

In one embodiment data encryption of the digital record or data file is achieved through the use of one or more quantum key distribution protocols, such as for example BB84 protocol or E91 protocol.

Preferably the digital data file is encrypted in use in one or more of the following scenarios: data at rest, such as for example when the data is stored in a database, file system or other storage media; data in transit, such as for example when the data is being transmitted between two or more different locations in the system; data in use, such as for example when data is being actively processed in the system; end-to-end encryption, such as for example when the data is encrypted from when it is created to when it is received/opened by the intended user.

Preferably decryption means or mechanism can be provided with and/or associated with the digital records system, the digital data platform, databases associated with the at least first and/or second user interfaces or digital data platform, and/or the at least first and/or second user interfaces. This typically allows encrypted data to be decrypted when required in use.

Preferably the digital data is arranged to be decrypted in one or more of the following scenarios: data at rest, such as for example when an authorised user requests data that is stored in a database, file system or other storage media; data in transit, such as for example when the data is being transmitted between two or more different locations in the system; data in use, such as for example when data is being actively processed in the system; end-to-end encryption, such as for example when the data is encrypted from when it is created and decrypted when it is received/opened by the intended user.

In one embodiment the at least first user interface is accessible by one or more first users. For example, the one or more first users could be the users generating the one or more digital records, the till and/or accounting staff at a retail outlet.

In one embodiment the at least second user interface is accessible by one or more customers or end users or the user receiving the one or more digital records in use

In one embodiment each user of the system or the user interface(s) has their own unique user interface which is accessible only to a particular authorised user. For example, each customer or retail outlet employee has their own uniquely accessible user interface.

In one embodiment a plurality of authorised users can access one of the user interfaces. For example a plurality of family members could access a single user interface or a plurality of staff members could access a single user interface.

Preferably the system is a universal system such that a plurality of separate, different, remotely located and/or independent users are each provided with the at least first user interface and a plurality of separate, different and/or independent users are each provided with the at least second user interface but they are all communicatively coupled to the digital data platform. Thus, for example, a plurality of different, independent retail outlets could be in communication with the digital data platform and a plurality of different, separate and independent customers could be in communication with the digital data platform.

In one embodiment one or more digital data platform interfaces are provided with and/or associated with the digital data platform and are preferably accessible by the digital records system provider and/or one or more authorised employees thereof.

Preferably security means are provided on and/or associated with one or more of the digital data platform interfaces so that only authorised users having the required security can access the user interfaces. For example, the security means may include one or more security passwords, pin numbers, biometric security means and/or the like.

In one embodiment the at least first and/or at least second user interfaces and/or the one or more digital data platform interfaces are graphical user interfaces arranged for display on display means and/or electronic devices, such as for example, display means provided with or associated with one or more electronic devices.

In one embodiment the at least first and/or second user interfaces and/or the one or more digital data platform interfaces comprise, consist or include any means or device(s) that allows interaction between a user and the same; one or more reading means, such as for example ID reading means ; an operative system or device; one or more electronic devices, micro-processing means or device; one or more software systems and/or the like.

For example, the ID reading means could be image capturing means or a camera provided on an electronic device, mobile phone and/or the like.

In one embodiment when the ID reading means reads and/or detects the ID means, the system is able to determine if a user interface is available for allowing receipt of the digital record via the electronic device provided with and/or associated with the ID reading means. If no user interface is detected, the system prompts the user to download the user interface to allow receipt of the digital record. If a user interface is detected, the system proceeds to verify the ID means via the digital data platform.

Preferably the means or device(s) that allows interaction between a user and the same; the one or more reading means, the operative system or device, the micro-processing means or device; the one or more electronic devices, the one or more software systems include, are provided with and/or associated with display means.

In one embodiment the at least first and/or second user interfaces form part of, are associated with or include an EPOS system (Electronic Point of Sale System).

Preferably the one or more electronic devices are provided with and/or associated with micro-processing means, such as for example, a mobile phone, a computer, a computer server, an electronic tablet, an Ipad, a hand held electronic device, electronic micro-processing device and/or the like.

Preferably the display means is in the form of or includes a touch screen display, a display screen, a liquid crystal display (LCD), a light emitting diode (LED) display and/or the like.

Preferably the one or more electronic devices via which the user interfaces are accessible include communication means or device to allow communication between the one or more electronic devices and therefore the different user interfaces of the system, and/or the digital data platform.

For example, the at least first user interface can be provided on and/or associated with at least a first electronic device, the at least second user interface can be provided on and/or associated with at least a second electronic device and the digital data platform or digital data platform interface can be provided on and/or associated with at least third electronic device.

Preferably the communication means provided with and/or associated with each electronic device allows the interfaces and the digital data platform to be communicatively coupled in one example.

In one embodiment the communication between the interfaces and/or the digital data platform can take place live, in real-time, at one or more pre-determined or selectable time intervals, at regular pre-determined time intervals, when activated to do so (such as for example of detection and/or reading of ID means), following a positive verification step having taken place (such as for example via the digital data platform) and/or the like.

Preferably the communication means of each electronic device allow one way, two way and/or multi-way communication with the same. Preferably the communication means can be via wired and/or wireless means.

Preferably the communication means can be via any or any combination of the Internet, WIFI, one or more Ethernet cables, one or more electrical cables, one or more Local Area Networks (LANs), one or more mobile data networks, one or more radio frequency signals, one or more low power wide area networks (LPWAN), Bluetooth, near field communication, Infra-red and/or the like.

In one embodiment one or more of the user interfaces are automatically activated and/or user or manually activated in use. Preferably activation can relate to opening of the user interfaces; generating, displaying, detecting and/or reading ID means; generating, sending and/or receiving one or more digital records, verification of ID means and/or the like.

In one embodiment a user has to pre-install system software or download an APP (mobile phone application) on their electronic device in order to provide or allow access to the first and/or second user interfaces.

In one embodiment, when an electronic device scans or reads an ID means relating to the system, the system is arranged to identify if the system software, APP and/or user interface is already installed on the electronic device that is doing the reading or scanning. Preferably, if the system detects that the system software, APP and/or user interface is installed on the electronic device, the digital data platform proceeds to undertake a verification step to allow the one or more digital records to be sent to the electronic device.

Preferably, if the system detects that the system software, APP and/or user interface is not installed on the electronic device, it provides a prompt to a user of the electronic device to download the system software, APP and/or user interface to allow the one or more digital records to be sent to the electronic device.

In one embodiment one or more of the user interfaces include user selectable options and/or means. For example, the one or more user selectable options can include any or any combination of user account registration, account setting management, password management, user contact details, manual input of records, automatic and/or digital input of records, accounting management, record management, allocation of records to databases or sub-databases, search and/or filtering facility and/or the like.

Preferably at least a first digital database is provided with and/or associated with the at least first user interface for storage of the one or more generated and/or received digital records or data files.

Preferably the first digital database and/or first user interface is provided on and/or associated with a first electronic device. For example, the first electronic device could be a POS device.

Preferably at least a second digital database is provided with and/or associated with the at least second user interface for storage of the one or more generated and/or received digital records or data files.

Preferably the second digital database and/or second user interface is provided on and/or associated with a second electronic device. For example, the second electronic device could be a mobile phone, glasses with image capture functionality and/or the like.

Preferably at least a third digital database is provided with and/or associated with the digital data platform and/or digital data platform interface for storage of digital records that have been generated, received and/or communicated via the digital records system in use.

Preferably the third digital database and/or digital data platform is provided on and/or associated with a third electronic device. For example, the third electronic device could be a computer server.

Preferably the first, second and/or third electronic devices have memory means provided on and/or associated with the same to allow storage of the first, second and/or third databases thereon or therewith respectively.

In one embodiment any or any combination of the digital databases are arranged to be any or any combination of searchable; filterable; can be divided into sub-databases to allow division of digital records, such as for example into pre-determined or user selectable categories; and/or the like.

Preferably the one or more databases can store the one or more digital records in any required, pre-determined and/or user selectable data format.

Preferably the one or more databases automatically formats the digital records into a required, pre-determined and/or user selectable data format.

In one embodiment a single digital record or data file containing a data set is generated by the system per transaction and/or event performed by the system in use. Alternatively, two or more copies of the digital record or data file can be generated for the same data set per transaction and/or event performed by the system in use. For example, at least one of the digital record copies or data files can be sent from the at least first user interface to the at least second user interface for storage in the at least second digital database, at least one of the digital record copies or data files can be stored in the at least first digital database and/or at least one of the digital record copies or data files can be stored in the at least one database of the digital data platform.

Thus, for example, where the at least first user interface is associated with a retail outlet and the at least second user interface is associated with a customer, a copy of a digital record in the form of a digital receipt can be stored at both the retail outlet's receipt database and the customer's receipt database. This allows for account management of the receipts at either or both the customer end and the retail outlet end of the system. A copy of the receipt can optionally also be stored at the database associated with the digital data platform.

In one embodiment the at least first and/or second user interfaces form part of, includes and/or is associated with a point of sale (POS) device or system, electronic point of sale (EPOS) or payment device or system and/or the like. For example, during or after a payment has been processed by the POS, EPOS or payment system in respect of a purchase, a digital receipt could be generated by the same.

Preferably the digital records system of the present invention is arranged to be communicatively coupled to different and independent EPOS systems in use. Thus, for example, a first retail outlet may use a first type of EPOS system and a second retail outlet may use a second type of EPOS system and the digital data platform can communicate with and process digital records from both EPOS systems.

In one embodiment the digital data platform is hosted and/or located on a computer server, on a computer, further electronic device, in the cloud and/or the like.

In one embodiment the digital data platform includes at least one digital data platform database or at least one relational platform database.

In one embodiment the digital data platform is arranged to undertake a verification process on detection of ID means generated by one of the user interfaces by the ither user interface.

Preferably once the digital data platform has positively verified the ID means and the first and/or second user interfaces, the digital data platform allows communication or communicative coupling to take place between the first and/or second user interfaces directly, indirectly and/or via the digital data platform.

In one embodiment once the digital data file or record is sent to the digital data platform, the digital data platform can perform one or more processing steps to the file or record prior to saving a copy of the same and/or forwarding a copy of the same to the first and/or second user interfaces.

Preferably searching, filtering, verification and/or formatting means are provided with and/or associated with the digital data platform, digital data platform database and/or relational database so as to, for example, verify ID means, identify data, extract relevant data from the digital records or data files, verify relevant data, filter relevant data from the generated records or data files, undertake one or more processing steps on the record or data file and/or format data in the generated records or data files.

Preferably the searching, filtering, verification and/or formatting means allows searching, filtering, verification and/or formatting to take place automatically and/or on user activation according to one or more pre-determined criteria, one or more first and/or second user selectable criteria and/or one or more system provider selectable criteria.

Preferably the digital data platform is arranged to undertake the searching, filtering, verification and/or formatting means automatically once one or more pre-determined criteria are met.

In one embodiment the digital data platform is arranged to perform a verification process or step to verify that the first and/or second user interfaces are able to send and/or receive the one or more digital records in use and/or that the ID means detected, read and/or communication is a valid ID means.

Preferably the sending and/or receiving of the one or more digital records between the first and/or second user interfaces takes place directly between the same or takes place indirectly via the digital data platform.

In one example, the one or more pre-determined criteria include receipt or communication of a data file, ID means and/or digital record.

In one embodiment the searching means may be arranged to search data such as user ID, customer name, retail outlet name, user name, contact details, other unique identifiers and/or the like.

In one embodiment the filtering means may be arranged to filter data based on user roles or status, activity status, one or more dates or date ranges and/or the like.

In one embodiment the verification means may be arranged to verify a user's identification or ID means. For example, the verification means could include multi-factor authentication (MFA), one time passwords (OTPs), knowledge based authentication KBA), software identification and/or the like.

In one embodiment formatting means can be used to format, display, process and/or present data in a pre-determined or user selectable manner, such as for example using CSV, Excel, PDF and/or the like.

Preferably digital software includes software and/or hardware to allow searching, filtering, verification and/or formatting means to take place.

In one embodiment the digital data platform is arranged to allow integration with other systems, such as for example, user authentication systems (i.e. OAuth, SAML), identity management solutions (i.e. Active Directory, LDAP), third party verification systems and/or the like.

In one embodiment the digital records system, the digital data platform and/or any or any combination of the user interfaces use artificial Intelligence (AI) to search, filter, verify and/or process the one or more digital records and/or ID means. For example, AI could be used to read or scan the data in a digital receipt and calculate the amount of VAT payable on the monetary amount in the digital receipt and/or the like.

In one embodiment AI is used to learn the behaviour of a user or users of the system. The can allow the system to provide insights into the spending behaviour, analyse a user's spending and/or accounting requirements, generate financial reports, perform tax calculations, allow automatic filing of the digital data record or file and/or analyse patterns of a user or users of the system.

For example, python-based AI can be used with the digital data platform, the first user interface and/or the second user interface.

For example, one or more AI algorithms can be used to analyse and categorise extracted data from the one or more data digital files or records based on one or more pre-defined criteria, rule and/or user preferences. This could include, for example, identifying expense categories, allocating expenses to specific cost centres or projects, flagging anomalies or irregularities and/or the like.

In one embodiment the digital data platform, the at least first and/or second users, and/or the at least first and second user interfaces can include one or more web portals or have one or more web portals associated with the same.

In one embodiment the digital data platform includes middleware, one or more Application Programming Interfaces (APIs) and/or the like.

In one embodiment the digital data platform includes a digital data platform user interface accessible by the system provider.

Preferably the digital data platform user interface can be used to monitor the transactions taking place on the system, the users of the system, the digital records generated and/or communicated by the system, the manual records communicated by the system and/or the like.

Preferably the ID means are unique ID means that are unique to a user or user(s) of the at least first user interface and/or the at least first user interface, and/or are unique to a user or user(s) of the at least second user interface and/or the at least second user interface. In one embodiment the ID means is unique to each transaction and/or event undertaken by the system. Thus, for example, every digital record that is sent via the system is associated with and/or provided with a unique ID means.

In one embodiment the ID means may contain a unique reference or identifier to the retailer, first user and/or first user interface, and a unique reference or identifier to the end user, customer, second user and/or second user interface.

In one embodiment the ID means or unique ID means is any or any combination of one or more numbers, letters, images, symbols, barcodes, codes, QR codes, API key and/or the like.

In one embodiment the system, the one or more user interfaces and/or the one or more electronic devices used in the system includes and/or are associated with ID reading and/or detection means for reading the ID means and/or detecting the ID means in use.

Preferably the ID reading means includes any or any combination of a barcode reader, image capturing means, one or more cameras, scanners, QR code reader and/or the like.

Preferably the ID reading means are provided on and/or associated with the at least first user interface and/or the at least second user interface, the electronic devices on which the at least first and/or second user interfaces are accessed by and/or the like.

Thus, in one embodiment, ID means can be displayed and/or generated by the at least first user interface or first electronic device and can be read by the ID reading means provided on and/or associated with the at least second user interface or second electronic device. For example, a QR code could be generated by a retail outlet following a purchase transaction by a customer and a customer could scan the generated QR code with a camera of their mobile phone to allow a purchase receipt to be sent from the retail outlet to the customer for the purchase transaction directly or indirectly via the digital data platform.

In one embodiment, the ID means can be displayed and/or generated by the at least second user interface or second electronic device and can be read by the ID reading means provided on and/or associated with the at least first user interface or first electronic device. For example, a customer could present their unique ID means or QR code to a retail outlet following a purchase transaction by the customer, the ID reading means at the retail outlet can read the QR code and then generate a digital purchase receipt and send the same to the customer.

Preferably the digital record is only communicated between the at least first and second user interfaces once a positive verification of the ID means has been made by the at least first and/or second user interfaces, the digital data platform interface and/or digital data platform following reading and/or detection of the same in use.

In one embodiment communication of the one or more digital records between the at least first and second user interfaces requires a positive verification of the ID means to take place via the digital data platform.

For example, once one of the user interfaces detects and/or reads an ID means, the ID means can be sent, detected and/or communicated to or by the digital data platform for verification as being a registered, authorised and/or known user ID means of the system. Once the digital data platform has positively verified the ID means, the digital record associated with the ID means can then be communicated between the user interfaces via the digital data platform or directly between the user interfaces.

Preferably if positive verification does not take place in respect of the ID means, no communication of the one or more digital records takes place between the user interfaces via the digital data platform.

In one embodiment the system is arranged to allow repeat of a verification process of the ID means if a verification process fails.

In one embodiment at least part of the verified ID means is associated with, attached to and/or embedded in the digital record prior to communication of the digital record to ensure that the digital record is communicated between the correct and verified user interfaces.

For example, when a digital record is created in the system, a unique identifier or unique ID means are generated for, attached to, embedded with and/or associated with that record. This unique identifier or unique ID means can serve as a link between the digital record and the identifier or ID means.

In one embodiment the link between the ID means and the digital record is maintained for as long as the digital record is maintained in the system (i.e. it is permanently attached to or associated with the record)

In one embodiment the link between the ID means and the digital record is only temporarily maintained for a pre-determined time period, such as for the period of communication of the digital record between user interfaces and/or the like.

In one embodiment the verified ID means allows a communication portal to be opened between the user interfaces to allow the digital record to be communicated directly or indirectly between the same.

Preferably the at least first and/or second user interfaces have user selection means to allow selection of a received and/or generated digital record or data file to allow viewing of the same on the display means.

In one embodiment, the one or more of the digital records or data files stored in the at least first and/or second databases can be sent to a further third party user interface, electronic device, computer and/or the like via suitable communication means. This can take place live or at a pre-determined or selectable time point in the future. Thus, for example, a customer or user at a retail outlet could forward their digital receipts to an accountant for tax and/or accounting purposes.

Preferably the at least first and/or second user interfaces are provided via a mobile phone APP, Application Programming Interface (API) and/or the like.

Preferably the system and/or digital platform is arranged to communicate with different POS, EPOS or payment systems; different AIPs or phone Apps, software and/or the like.

Preferably the system and/or digital platform is arranged to process different data formats of digital records.

In one embodiment a user does not have to open the user interface in order to allow the ID means to be read and/or detected in use. For example, ID reading means, a camera or image capture means on the electronic device could be used to detect the ID means without the associated user interface being actively open on the electronic device.

In one embodiment, once the ID reading means, camera or image capture means on an electronic device have identified an ID means, the electronic device automatically opens the interface associated with the device and/or allow communication of the one or more digital records to the electronic device in use.

In one embodiment, the ID means could be provided on a physical card or ID item and could be read by the ID reading means to allow a digital record to be communicated between the at least first and second user interfaces. For example, if a customer did not have their mobile phone with them, they could present an ID card including their ID means to the user at the retail outlet to allow a digital receipt to be generated and sent from the retail outlet to the customer's user interface for viewing at a later time.

Preferably the at least first and second user interfaces are different, belong to different and/or unrelated user's, different organisations and/or the like.

In one embodiment the at least first user interface is associated with a retail outlet, public body, organisation, institute, business and/or the like.

In one embodiment the at least second user interface is associated with a customer, end user and/or the like.

Preferably the digital data platform is provided by the system owners, owners of the APP and/or the like.

In one embodiment the generated digital record exists for a pre-determined period of time, indefinitely, for as long as a user of the at least first and at least second user interfaces requests or selects and/or the like.

In one embodiment a digital record can be manually added to the system, to the at least first and/or second user interfaces, to the at least first and/or second databases, digital data platform and/or the like. For example, the digital data record can be brought in to the system manually via any suitable means, such as via a text messaging service, e-mail, image capturing means, download and/or the like.

Preferably the search means and/or filtering means can be provided with and/or associated with the digital records system, with the at least first and/or second user interfaces, with the at least first and/or second databases, with the digital data platform and/or the like. This allows a user to search and/or filter data using one or more pre-determined criteria and/or user selectable criteria in use.

In one embodiment, in order for a user to access and/or use the digital data system they will be issued with their own unique ID means.

According to a second aspect of the present invention there is provided a digital record/receipt system;
said digital record/receipt system including:
a digital data platform;
at least a first user interface provided on and/or associated with a first electronic device;
at least a second user interface provided on and/or associated with a second electronic device;
each of the at least first and second user interfaces communicatively coupled to the digital data platform;
wherein the at least first user interface is arranged to generate and/or have access to one or more digital records/receipts relating to a transaction and/or event in use, and the at least second user interface is arranged to receive the one or more digital records/receipts in use;
wherein at least one of the at least first and second user interfaces is arranged to display and/or generate identification (ID) means and the other of the at least first and second user interfaces or the associated electronic device is arranged to read and/or detect the ID means;
and wherein said digital data platform is arranged such that once the ID means are read and/or detected, it allows communication between the at least first and second user interfaces to take place such that the one or more digital records/receipts can be sent from the at least first user interface to the at least second user interface.

According to a third aspect of the present invention there is provided a method of using a digital records system; said digital records system including:
a digital data platform;
at least a first user interface;
at least a second user interface;
each of the at least first and second user interfaces communicatively coupled to the digital data platform;
wherein at least one of the at least first and second user interfaces is arranged to generate and/or have access to one or more digital records in use, and the other of the at least first and second user interfaces is arranged to receive the one or more digital records in use;
said method including the steps of at least one of the first and second user interfaces displaying and/or generating identification (ID) means;
the other of the at least first and second user interfaces reading and/or detecting the ID means;
the digital data platform allowing communication between the at least first and second user interfaces once the ID means are read and/or detected by the other of said first and second user interfaces;
sending the one or more digital records from said one at least first and second user interfaces to the other of said at least first and second user interfaces directly, indirectly and/or via the digital data platform.

According to a further aspect of the present invention there is provided a method of using a digital receipt system.

According to a fourth aspect of the present invention there is provided a digital data platform for use in a digital record system and/or digital receipt system.

According to a fifth aspect of the present invention there is provided a method of using a digital data platform.

According to various independent aspects of the present invention there is provided at least a first user interface, at least a second user interface and/or a digital data platform interface for use in a digital records system and/or digital receipt system.

According to various independent aspects of the present invention there is provided a method of using at least a first user interface, at least a second user interface and/or a digital data platform interface.

Detailed embodiments of the present invention will now be described with reference to the following figures, wherein:

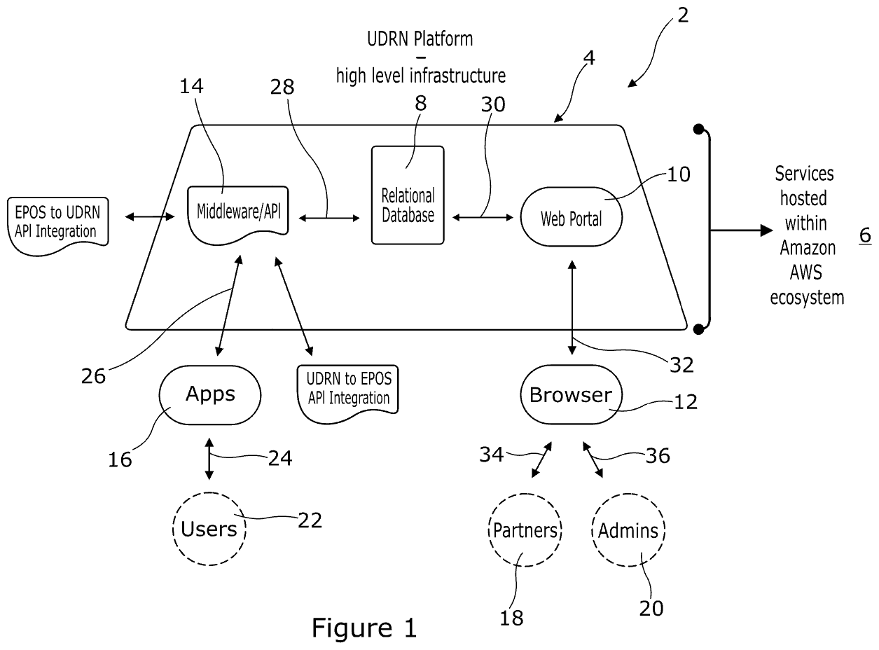

FIG. 1 is a schematic diagram of the digital records system according to one embodiment of the present invention;

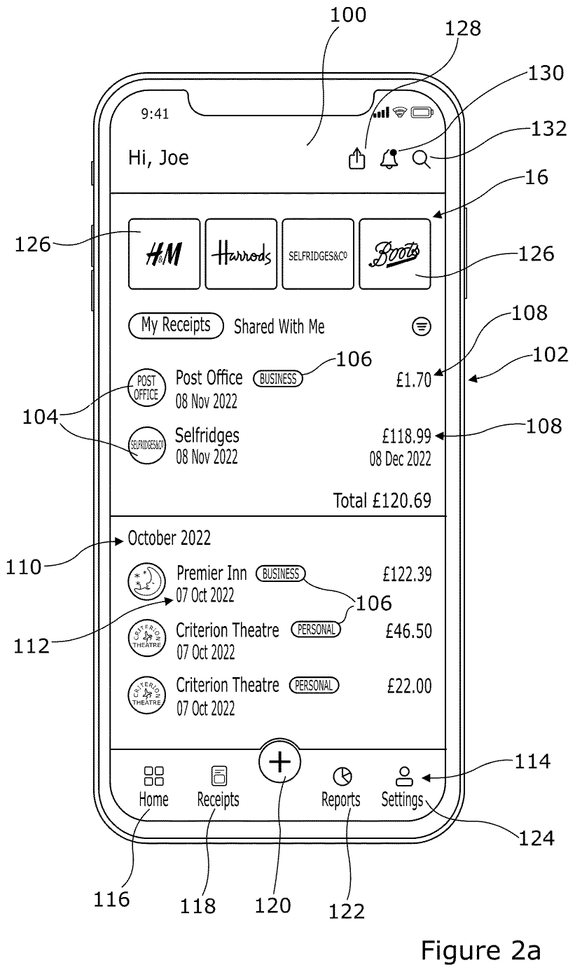

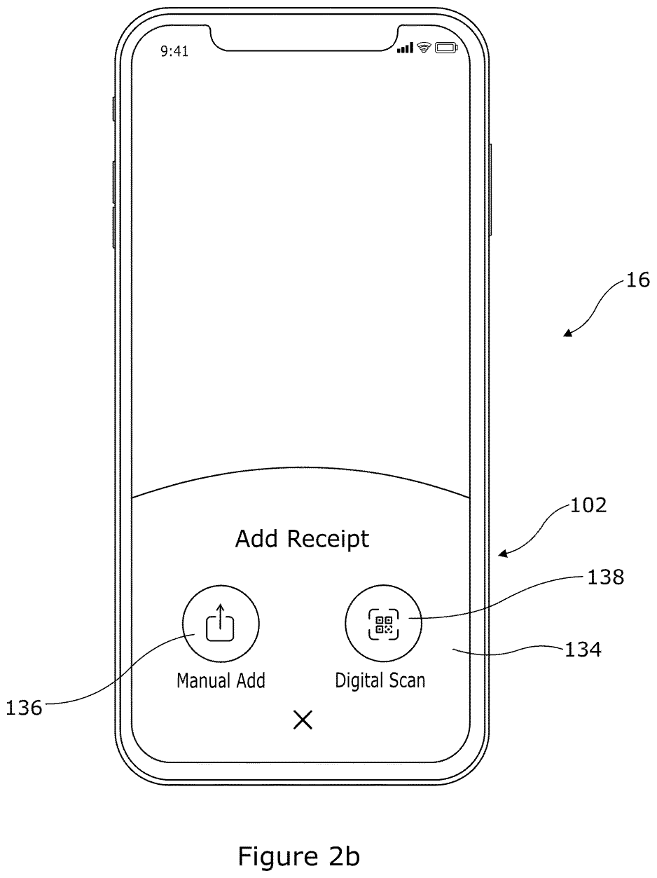

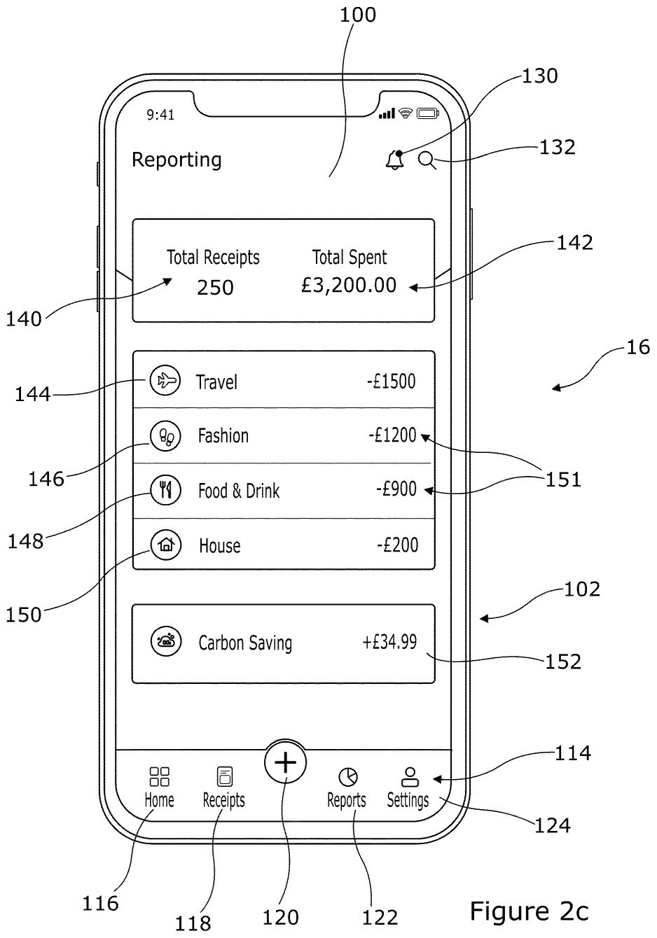

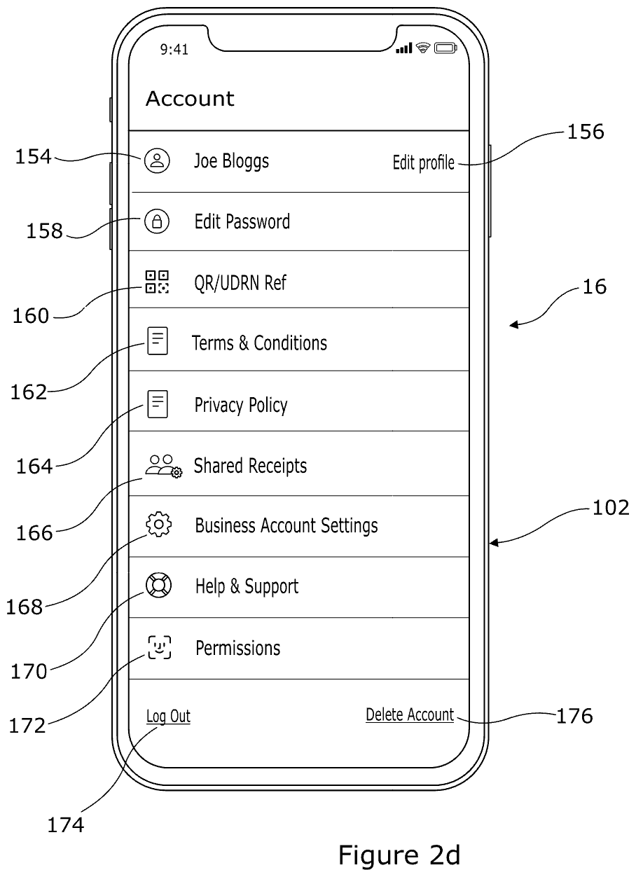

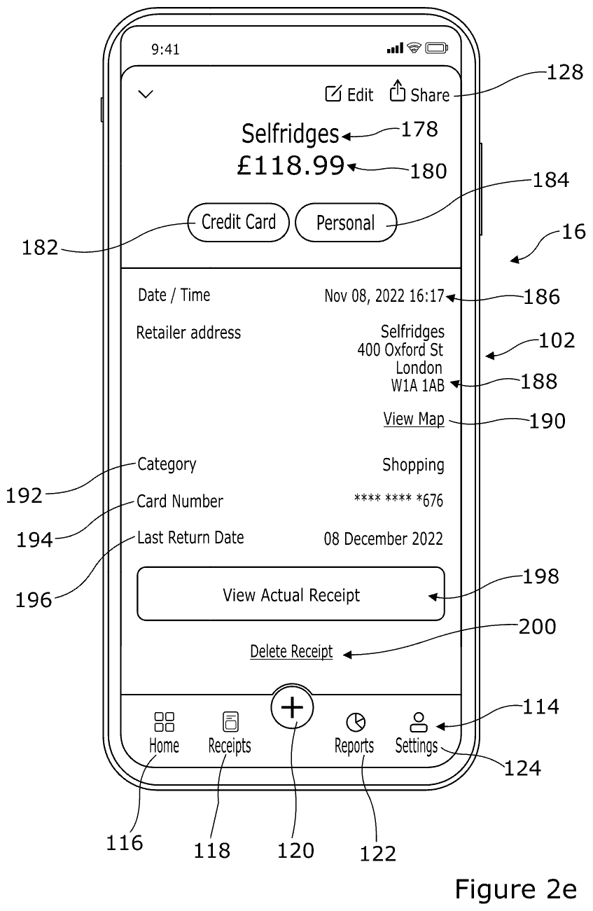

FIGS. 2a-2e show example screenshots of a graphical user interface, such as for example, a user interface associated with a customer or second user interface, shown on a mobile phone;

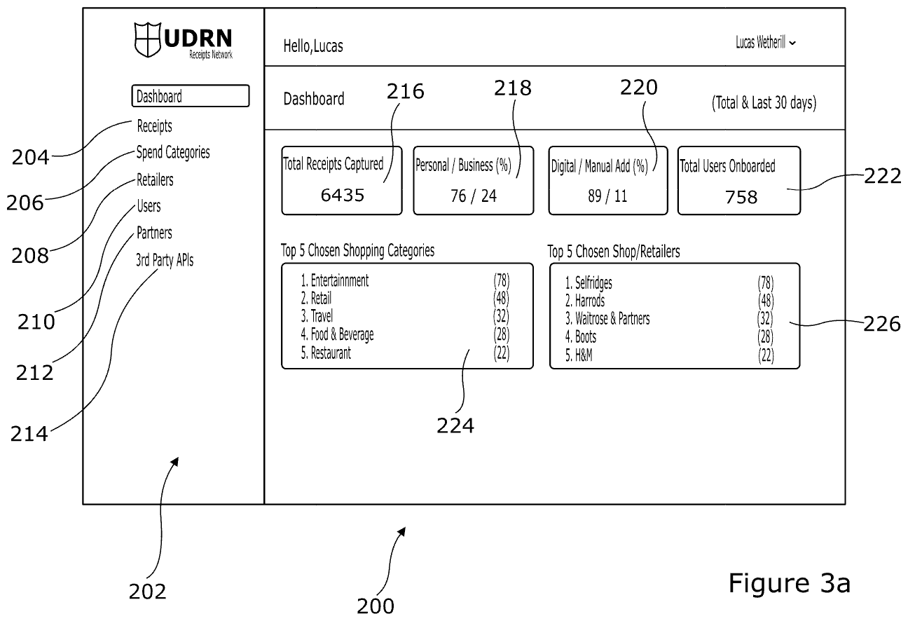

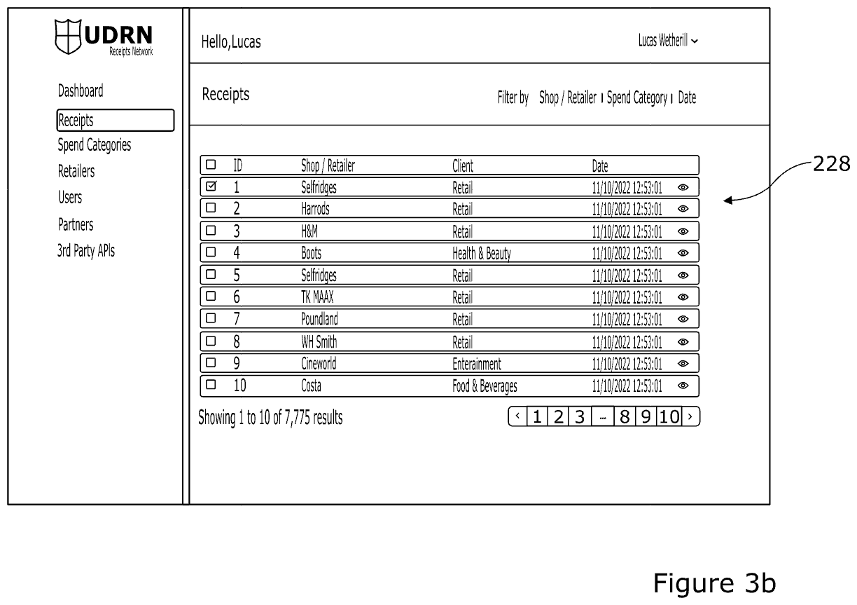

FIGS. 3a-3b show examples of a dashboard/user interface that can be accessed via the digital data platform and used by the system provider to show details of data records or receipts that have been processed by the system.

According to an embodiment of the present invention, there is provided a digital data records system in the form of a digital receipt system. In a simple form of one embodiment of the present invention, the digital receipt system allows digital receipts comprising one or more digital receipt data files to be generated by one or more different retail outlets and securely sent to one or more different customers for storage in one or more digital databases via an application (app), hardware and/or software provided on and/or associated with an electronic device. This allows for the elimination of paper receipts, thereby saving money for retail outlets and benefitting the environment. It makes the transaction process between a customer and a retail outlet at the point of purchase or point of sale (POS) significantly more efficient and streamlined, irrespective of the purchase method used by the customer, thereby enhancing the experience of both the customer and retail outlet. It removes the need for customers to transfer personal data to the retail outlet if they do not wish to, thereby increasing the privacy of the customer's data. It also provides an improved accounting system to allow a customer to track purchases, transactions and make budgeting decisions without the need to manually input receipts and/or scan receipts.

Further modifications of the present invention can allow a portal for refunds and returns to be made via the system; allows one way and/or two way communication to take place between a retail outlet and the customer; allows for branding and/or marketing opportunities for the retail outlet; allows sharing of receipts between a customer, retail outlet and/or selected parties, such as accounts departments, tax offices; allows for the carbon saving in using the digital receipt system to be calculated and displayed to the user and/or the like.

Referring to FIG. 1, there is shown a schematic diagram of a digital records system 2 according to an embodiment of the present invention. The digital records system 2 includes a digital data platform 4 that is hosted on a cloud server 6, such as for example via Amazon® AWS Ecosystem.

The digital data platform 4 includes at least one database in the form of at least one relational database 8, at least one web portal 10 for communication with a first user interface 12 in use, and middleware/API 14 for communication with a second user interface 16 in use. The first and second user interfaces are typically provided on and/or accessible via first and second electronic devices.

One or more users 18 and/or administrators 20 can access the at least first user interface 12. For example, the first user interface 12 could be associated with a retail outlet and the users 18 could be staff employed by the retail outlet and the administrators 20 could be administrators and/or accounts personnel of the retail outlet.

One or more users 22, such as for example a customer of a retail outlet, could access the second user interface 16.

Communication between the various interfaces and/or electronic devices of the system 2 can be one way or two way as shown by arrow 24 between user 22 and the second user interface; as shown by arrow 26 between the second user interface 16 and the middleware/API 14 of the digital data platform; as shown by arrow 28 between the relational database and the middleware/API 14 of the digital data platform; as shown by arrow 30 between the relational database and the web portal 10 of the digital data platform; as shown by arrow 32 between the web portal 10 and the first user interface 12; as shown by arrow 34 between the users 18 and the first user interface 12; and as shown by arrow 36 between the administrators 20 and the first user interface 12.

The middleware and API14 allow integration between different EPOS systems and the digital data platform (DDP), such as for example EPOS to DDP API integration and DDP to EPOS API integration.

In one example, once a customer 22 has made a purchase with the retail outlet via an electronic point of sale (EPOS) system, a till user 18 at the retail outlet will be prompted via the first user interface 12 to ask the customer 22 to scan the customer's unique ID means. The unique ID means might, for example, be in the form of a unique QR code allocated to the customer 22 via the system. The ID reading means might be in the form of a QR code reader provided at the till of the retail outlet that is associated with the first user interface 12 and/or EPOS.

Once the QR code reader has successfully read the customer's QR code, this causes the first user interface 12 to generate a digital receipt and to send the digital receipt to the digital data platform 4. The digital data platform 4 might perform a verification process following reading of the QR code and before and/or after the digital receipt is generated and/or sent from the first user interface to the digital data platform. The verification process firstly ensures that both the retail outlet and the customer are authorised users of the digital receipt system and secondly ensures that the correct digital receipt is associated with the correct customer's QR code and sent to the correct second user interface 16. The digital data platform typically sends the digital receipt and associated QR code using the middleware/API 14.

Once the second user interface has received the digital receipt, the customer can view the same via the second user interface.

In a further example, one a customer 22 has made a purchase with the retail outlet via an electronic point of sale (EPOS) system, a unique ID means is generated by the first user interface 12 and a till user 18 at the retail outlet could be prompted via the first user interface 12 to ask the customer 22 to scan the unique ID means using ID reading means. The unique ID means might, for example, be in the form of a unique QR code allocated to the customer specific transaction via the system. The ID reading means might be in the form of a mobile phone with a camera function that is associated with the second user interface 16 and customer.

Once the customer's phone has successfully read the unique transaction QR code, this causes the first user interface 12 to generate a digital transaction receipt and to send the digital receipt to the second user interface on the customer's mobile phone directly or via the digital data platform 4. The digital data platform 4 might perform a verification process following reading of the QR code by the customer's mobile phone and before and/or after the digital receipt is generated by the first user interface. The verification process firstly ensures that both the retail outlet and the customer are authorised users of the digital receipt system and secondly ensures that the correct digital receipt is associated with the correct customer's QR code and sent to the correct second user interface 16. The digital data platform typically sends the digital receipt and associated QR code using the middleware/API 14 or allows the digital receipt to be sent directly from the first user interface to the second user interface.

Once the second user interface has received the digital receipt, the customer can view the same via the second user interface.

The digital receipt can be encrypted via encryption means provided at the first user interface, the digital data platform and/or the second user interface to ensure security of the data sent, communicated, received and/or stored.

Databases are associated with the first user interface, the second user interface and/or the digital data platform and a copy of the digital receipt can be stored at any or any combination of the databases as required.

In one embodiment the web portal 10 allows an administration process to take place between the system provider and the EPOS system used by the retail outlet and to allow new retail outlets and/or EPOS systems to be added to the digital data platform. For example, a retail outlet may need to apply for ID means in the form of an API key in order to allow them to integrate with their EPOS system with the digital data platform. The web portal can also allow e-mails and notifications to be communicated between the various system components.

The second user interface 16 typically allows a customer to perform any or any combination of the following features; login, create a password, create an account, register on the system, generate a unique ID means, provide contact details, view a dashboard, add receipts, view receipts, share receipts, undertake accounting reports and/or functions, change settings in the interface, receive and/or send notifications and/or the like.

FIGS. 2a-2e show example screenshots of the second user interface 16. In this embodiment the second user interface 16 is a graphical user interface for display on a touch display screen 100 of a customer's mobile phone 102.

FIG. 2a is an example screen shot of the second user interface 16 showing a summary of the latest digital receipts received by the interface for the customer. Each receipt can include the branding 104 of the retail outlet from where the receipt came from, such as for example “The Post Office” or “Selfridges”, an identification 106 as to whether the receipt is a personal receipt or a business receipt, the monetary value 108 of the receipt, the time period 110 over which the receipts were received and the actual date 112 of the receipt.

A menu bar 114 can be displayed on the interface 16 to allow the user to quickly navigate to other selectable options of the interface, such as for example, a home page 116, a receipt page 118, an add receipt page 120, a summary report page 122 and a settings page 124.

The user may also be given the option to view all of their receipts relating to a particular retail outlet. For example, a plurality of retail outlet icons 126 could be displayed on the user interface for selection by a user. Once a particular icon is selected, just the receipts from those retail outlets would be displayed to the user.

Other selectable options include a receipt forwarding icon 128 to allow a user to forward a receipt to a third party, a notification icon 130 to allow a user to view any notifications they have received via the system, and a search icon 132 to allow a user to search for one or more receipts using pre-determined and/or user selectable criteria.

FIG. 2b is an example screenshot of the second user interface 16 showing an add receipt page. A menu bar 134 allows a user to select to add a receipt manually via icon 136 or add a receipt via scanning ID means 138 (such as the customer's QR code).

FIG. 2c is an example screenshot of the second user interface 16 showing a summary report page that could be generated in respect of the customer's receipts. The total number of receipts can be shown (reference numeral 140), the total amount of the purchase transactions relating to the receipts can be shown (reference numeral 142), the receipts can be categorised into retail sectors, such as travel 144, fashion 146, food and drink 148 and house costs 150, with the total receipt amounts for each sector listed (reference numeral 151). The carbon saving in using the digital receipts interface 16 could also be shown (reference numerals 152).

FIG. 2d is an example screenshot of the second user interface 16 showing various user selectable account options, such as name of the customer 154, the ability to edit their user profile 156, the ability to edit their user interface password 158, their unique ID means or QR code 160, the Terms & Conditions 162 of the App/user interface 16, the privacy policy 164 for the App/user interface 16, the option to share receipts 166, the ability to select certain business account settings 168, a help and support section 170, a permissions section 172, log out 174, and deletion of the user interface 176.

FIG. 2e is an example screenshot of the second user interface showing how a digital receipt may be viewed in the customer user interface 16. The receipt view can show the name of the retail outlet 178, the receipt monetary amount 180, identify which of the user's credit cards were used for the payment relating to the receipt 182, identify whether the receipt is for business or personal 184, the date and time the receipt was generated 186, the address of the retail outlet issuing the receipt 188, the ability to view a map showing the location of the retail outlet issuing the receipt 190, the retail sector the receipt is for 192, part of the number of the credit card used to make the payment 194, the last return date for the item if the item is returnable/refundable 196, view the actual receipt 198 and/or delete the receipt 200.

FIGS. 3a and 3b show examples of a dashboard 200 that could be provided with the digital data platform for use by users of the system provider to show digital receipts that have been processed using the system. A user selectable menu 202 could be provided to allow selection of one or more user selectable options, such as a list of receipts 204, spend categories for the receipts 206, a list of retailers using the system 208, a list of users/customers using the system 210, a list of third party partners of the system 212, a list of third party selectable APIs 214 that are used with the system and/or the like.

In addition, the dashboard could include the number of receipts captured by the system 216, the % receipts captured by the system that are personal or business 218, the % receipts captured by the system that have been digitally added or manually added 220, the total users/customers using the system 222.

Receipt data could also be shown by a ranking or selectable hierarchy order, such as the top 5 shopping categories of receipts issued by the system 224, and the top 5 retail outlets issuing receipts via the system 226.

The individual receipts could also be listed 228 showing the retail sector the receipt relates to, the date and time of issuance of the receipt and the name of the retail outlet. Any of the receipts could be selected and viewed by the system provider if required.

In one embodiment the generation of a digital receipt or data file can take place via one of two possible routes. In one route, the retailer or first user or retailer outlet will ask the second user or customer to provide their unique ID QR code. The first user will scan this QR code using ID reading means and, on verification of the QR code by the digital data platform, the first user interface and/or the digital data platform will associate the QR code with the digital receipt and send the combined data set to the digital data platform. The digital data platform will then record this combined digital data set and assign the combined digital data set to the customer with the associated QR code contained in the combined digital data set. The combined digital data set is then sent to the customer with the associated QR code.

If the receipt communication and/or ID verification process fails, this is communicated to the retail outlet, the system provider and/or the customer and a prompt may be given to ask for the relevant users to repeat the receipt communication and/or ID verification process again.

In the second option, the first user or retail outlet will present the second user or customer with a unique ID means, such as a QR code, on completion of a purchase transaction. This QR code may be directly associated with the generated receipt or may be separate to the same. The customer would scan the QR code using the image capturing camera on their mobile phone until a positive verification has been made via the digital data platform. Once positive verification has been made, the digital data platform then communicates with the first user or retail outlet to combine the ID means of the customer with the ID means of the first user and with the generated receipt to form a combined data set. The digital data platform then records this combined digital data set and sends a copy of the same is then sent from the first user to the second user via the digital data platform.

In one embodiment a digital receipt that has been generated and sent from a first user interface or retail outlet to a second user interface or customer can be sent back to the first user interface or retail outlet from the second user interface or customer via the digital data platform. For example, a customer may wish to request a refund of an item they have purchase and for which a digital receipt was generated and sent to them. The customer can send the digital receipt back to the retail outlet who verifies the authenticity of the digital receipt, such as for example using the original verification method. Once verified, the retail outlet can process the refund. A further digital receipt may optionally be provided by the retail outlet in respect of the refund. Other examples where a digital record may be sent back from the customer to the retail outlet can include a warranty claim, a price adjustment, a customer enquiry, a product recall or safety alert and/or the like.

In one embodiment the second user interface or customer may generate the digital record, such as for example an invoice, and send the same to the first user interface or retail outlet via the digital data platform. The retail outlet can then process a purchase transaction in respect of the invoice and issue a digital receipt as per the present invention.

1. A digital records system; said digital records system including:
a digital data platform;
at least a first user interface;
at least a second user interface;
each of the at least first and second user interfaces communicatively coupled to the digital data platform;
wherein at least one of the at least first and second user interfaces is arranged to generate and/ or have access to one or more digital records in use, and the other of the at least first and second user interfaces is arranged to receive the one or more digital records in use;
wherein at least one of the first and second user interfaces is arranged to display and/or generate identification (ID) means and the other of the at least first and second user interfaces is arranged to read and/or detect the ID means; and
wherein said digital data platform is arranged such that once the ID means are read and/or detected by the other of said first and second user interfaces, it allows communication between the at least first and second user interfaces to take place such that the one or more digital records can be sent from said one at least first and second user interfaces to the other of said at least first and second user interfaces directly, indirectly and/or via the digital data platform.

2. The digital records system according to claim 1, wherein said one at least first or second user interface that is arranged to generate and/or have access to the one or more digital records is the same user interface that is arranged to display and/or generate the ID means in use, and said other first or second user interface that is arranged to receive the one or more digital records is the same user interface that is arranged to read and/or detect the ID means in use.

3. The digital records system according to claim 1, wherein the digital record is any or any combination of one or more digital data files, receipts, transaction records, point of sale receipts, purchase and/or sale transaction receipts, tickets, tokens, certificates, invoices, pro-forma invoices, banking or financial transactions, or prescriptions.

4. The digital records system according to claim 1, wherein the digital record is generated at the start of, as a result of, during and/or following completion of a purchase, return of a purchased item, refund of a purchased item, a financial transaction and/or a sale transaction; or the digital record that is accessible to the first or the second user interface is a pro-forma invoice, pre-prepared invoice, returns invoice or invoice issued prior to a purchase or financial transaction taking place.

5. The digital records system according to claim 1, wherein the one or more digital records are encrypted or are capable of being encrypted by encryption means or quantum encryption means provided with and/or associated with the digital records system, the digital data platform, databases associated with the at least first and/or second user interfaces or digital data platform, and/or the at least first and/or second user interfaces; and/or wherein decryption means are provided with and/or associated with the digital records system, the digital data platform, databases associated with the at least first and/ or second user interfaces or digital data platform, and/or the at least first and/or second user interfaces.

6. (canceled)

7. The digital records system according to claim 1, wherein one or more digital data platform interfaces are provided with and/or accessible with the digital data platform and wherein the one or more digital data platform interfaces, the at least first user interface and/or the at least second user interface are graphical user interfaces arranged for display on display means and/or on one or more electronic devices.

8. (canceled)

9. (canceled)

10. The digital records system according to claim 1, wherein the user interfaces are accessible via one or more electronic devices and said electronic devices include communication means for allowing communication between the user interfaces of the system in use.

11. The digital records system according to claim 1, wherein digital databases are provided with and/or associated with the at least first user interface, the at least second user interface and/or the digital data platform or a digital data interface for storage of the one or more digital records in use.

12. (canceled)

13. The digital records system according to claim 1, wherein searching, filtering, verification and/or formatting means are provided with and/or associated with the digital data platform, a digital data platform database or a relational platform database to allow searching, filtering, verification and/or formatting of the one or more digital records and/or ID means in use.

14. The digital records system according to claim 13, wherein the searching, filtering, verification and/or formatting takes place automatically and/or on user activation according to one or more pre-determined criteria including receipt, detection or communication of a data file, digital record and/or ID means.

15. The digital records system according to claim 1, wherein the system, the digital data platform, the first user interface and/or at the at least second user interface uses artificial intelligence (Al) to search, filter, verify, process, organise and/ or analyse the one or more digital records and/or ID means in use.

16. The digital records system according to claim 1, wherein the digital data platform, the at least first user interface and/or the at least second user interfaces include one or more web portals or have one or more web portals associated with the same.

17. The digital records system according to claim 1, wherein the ID means is any or any combination of unique ID means, unique ID means associated with each transaction or event undertaken by the system, one or more numbers, letters, images, symbols, barcodes, codes, QR codes, or API key.

18. The digital records system according to claim 1, wherein the system, the one or more user interfaces and/or the one or more electronic devices used in the system include and/or are associated with ID reading means for reading and/or detecting the ID means in use.

19. The digital records system according to claim 18, wherein the ID reading means is any or any combination of barcode reader, image capturing means, one or more cameras, scanners, or QR code reader.

20. The digital records system according to claim 1, wherein the system is arranged such that the digital record is only communicated between the at least first and second user interfaces once a positive verification of the ID means has been made by the at least first user interface, the at least second user interface and/or the digital data platform.

21. The digital records system according to claim 1, wherein at least part of the ID means or verified ID means are associated with, embedded with and/or attached to the digital record prior to communication of the digital record.

22. A method of using a digital records system; said digital records system including:
a digital data platform;
at least a first user interface;
at least a second user interface;
each of the at least first and second user interfaces communicatively coupled to the digital data platform;
wherein at least one of the at least first and second user interfaces is arranged to generate and/ or have access to one or more digital records in use, and the other of the at least first and second user interfaces is arranged to receive the one or more digital records in use;
said method including the steps of at least one of the first and second user interfaces displaying and/or generating identification (ID) means;
the other of the at least first and second user interfaces reading and/or detecting the ID means;
the digital data platform allowing communication between the at least first and second user interfaces once the ID means are read and/or detected by the other of said first and second user interfaces;
sending the one or more digital records from said one at least first and second user interfaces to the other of said at least first and second user interfaces directly, indirectly and/or via the digital data platform.

23. The method of claim 22, wherein said one first or second user interface generating and/or accessing the one or more digital records is the same user interface that is displaying and/or generating the ID means, and said other first or second user interface that is receiving the one or more digital records is the same user interface that is reading and/or detecting the ID means.

24. The method of claim 22, wherein said digital data platform allows communication between the at least first and second user interfaces on verification of the ID means.
